(19) United States
(12) Patent Application Publication
(10) Pub. No.: US 2016/0005018 A1
(43) Pub. Date: Jan. 7, 2016

(54) POINT OF SALE (POS) SYSTEM AND OPERATION METHOD THEREOF

(71) Applicant: BETHEL Computer Consultant Co., Ltd., Kaohsiung City (TW)

(72) Inventor: Chih-Cheng Huang, Kaohsiung City (TW)

(21) Appl. No.: 14/467,059

(22) Filed: Aug. 25, 2014

(30) Foreign Application Priority Data
Jul. 3, 2014 (TW) 103123033

(51) Int. Cl. G06Q 20/20; G06Q 20/40

(52) U.S. Cl. CPC G06Q 20/202; G06Q 20/40

(57) ABSTRACT

A point of sale (POS) system includes a cloud server and a terminal device. The cloud server includes a sales database, and a verification module for storing a set of predetermined account data. The terminal device includes a network unit for linking to the cloud server via Internet, and a sales module for generating a set of sales data according to user input . Wherein when the terminal device logins the cloud server via Internet according to a set of user account data, and the verification module determines the set of user account data corresponding to the set of predetermined account data, the terminal device downloads peripheral device setting data from the cloud server for setting the terminal device to link to a peripheral device, and the terminal device uploads the set of sales data to the sales database.

### BACKGROUND OF THE INVENTION

1. Field of the Invention

The present invention relates to a point of sale system and an operation method, and more particularly, to a point of sale system and an operation method capable of replacing a point of sale terminal device immediately.

2. Description of the Prior Art

In a single store or a chain store, hardware of a point of sale (POS) terminal device generally is a regular personal computer or an integrated touch control host for performing stand-alone operation, and linked to a company server via network; and software of the point of sale terminal device generally provides functions of sales purchasing management, member management and cashier. In addition, the point of sale terminal device is connected to a sales data printing device or a barcode scanner for printing receipt or meal detail, or for scanning barcode of merchandise. The point of sale terminal device is not only utilized for merchandise sales and checkout, but also utilized for collecting business data for analyzing.

However, in a conventional structure of the point of sale terminal device, the point of sale terminal device may have software or hardware failure during business hours, and the store needs to report to a manufacturer for repairing. The manufacturer then replaces the original point of sale terminal device with a backup point of sale terminal device for maintaining partial function, and re-installs peripheral devices on the backup point of sale terminal device. After several days, the manufacturer replaces the backup point of sale terminal device with the repaired point of sale terminal device, confirms peripheral device connection again, and completes software parameter settings to each peripheral devices, where the settings are complex to a salesperson.

Therefore, the backup point of sale terminal device of the prior art is unable to continue cashier or order operations when the original point of sale terminal device is out of order, such that the store may have trouble to do business, and overall sales purchasing management may be affected, so as to bring inconvenience to the store, and increase labor cost and customer complaint to the manufacturer.

### SUMMARY OF THE INVENTION

The present invention provides a point of sale (POS) system comprising a cloud server and a terminal device. The cloud server comprises a sales database, and a verification module configured to store a set of predetermined account data. The terminal device comprises a network unit configured to link to the cloud server via Internet, and a sales module configured to generate a set of sales data according to user input. Wherein when the terminal device logins the cloud server via Internet according to a set of user account data, and the verification module determines the set of user account data corresponding to the set of predetermined account data, the terminal device downloads peripheral device setting data from the cloud server for setting the terminal device to link to a peripheral device, and the terminal device uploads the set of sales data to the sales database.

The present invention further provides an operation method of a point of sale system, comprising providing a cloud server comprising a sales database, and a verification module configured to store a set of predetermined account data; a terminal device installing a sales module and logging in the cloud server via Internet according to a set of user account data; the verification module determining whether the set of user account data corresponds to the set of predetermined account data; the terminal device downloading peripheral device setting data from the cloud server for setting the terminal device to link to a peripheral device when the verification module determines the set of user account data corresponding to the set of predetermined account data ; and the sales module of the terminal device generating a set of sales data according to user input, and the terminal device uploading the set of sales data to the sales database.

In contrast to the prior art, when the terminal device is out of order, the point of sale system of the present invention can re-download required data to a backup terminal device from the cloud server via Internet, in order to completely replace the original terminal device with the backup terminal device. Therefore, the terminal device of the point of sale system of the present invention can improve shortcoming of a conventional point of sale system unable to continue working when the terminal device is out of order, and break through limitation of the conventional point of sale system unable to work in a cross-platform environment, so as to greatly increase convenience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a point of sale system of the present invention.

FIG. 2 is a diagram illustrating a terminal device of the present invention logging in a cloud server.

FIG. 3 is a flowchart showing the terminal device of the present invention logging in the cloud server.

FIG. 4 is a diagram illustrating a backup terminal device of the present invention logging in the cloud server for replacing the terminal device.

FIG. 5 is a flowchart showing the backup terminal device of the present invention logging in the cloud server for replacing the terminal device.

### DETAILED DESCRIPTION

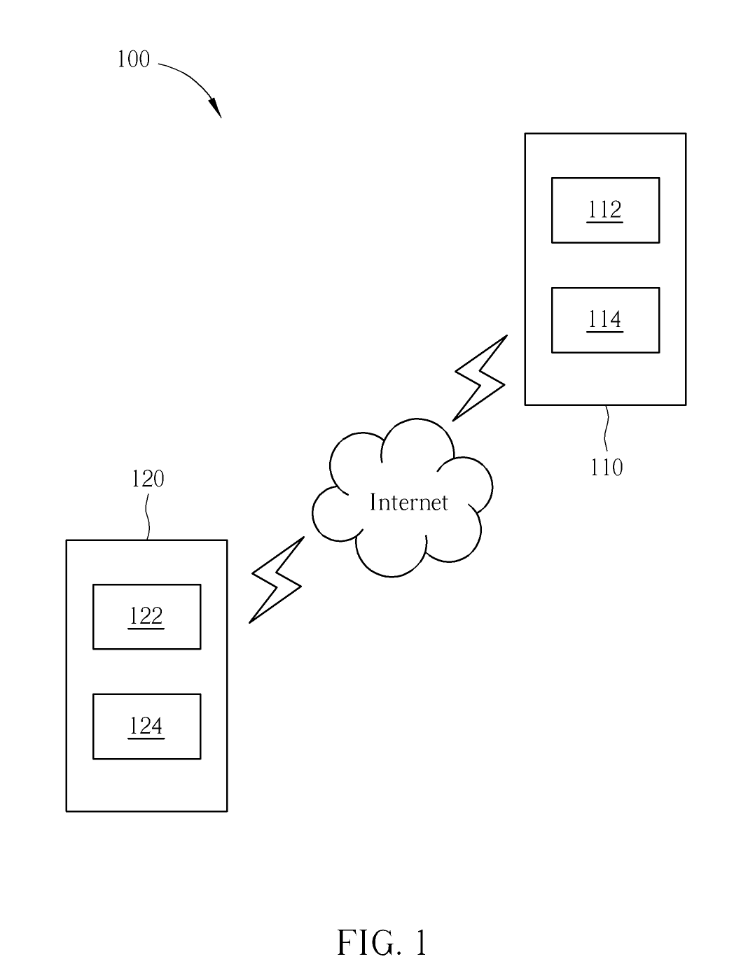

Please refer to FIG. 1. A point of sale system 100 of the present invention comprises a cloud server 110, and at least one terminal device 120. The cloud server 110 comprises a sales database 112, and a verification module 114. The sales database 112 is configured to store sales data uploaded by the terminal device 120. The verification module 114 is configured to store at least one set of predetermined account data, for verifying the terminal device 120 when logging in the cloud server 110. The terminal device 120 comprises a network unit 122 and a sales module 124. The network unit 122 is configured to link to the cloud server 110 via Internet, in order to allow the terminal device 120 to login the cloud server 110 via Internet. The sales module 124 is configured to generate a set of sales data according to user input. For example, the sales module 124 can generate a set (or a plurality of sets) of sales data corresponding to sold merchandise. The sales module 124 can be application software installed in the terminal device 120.

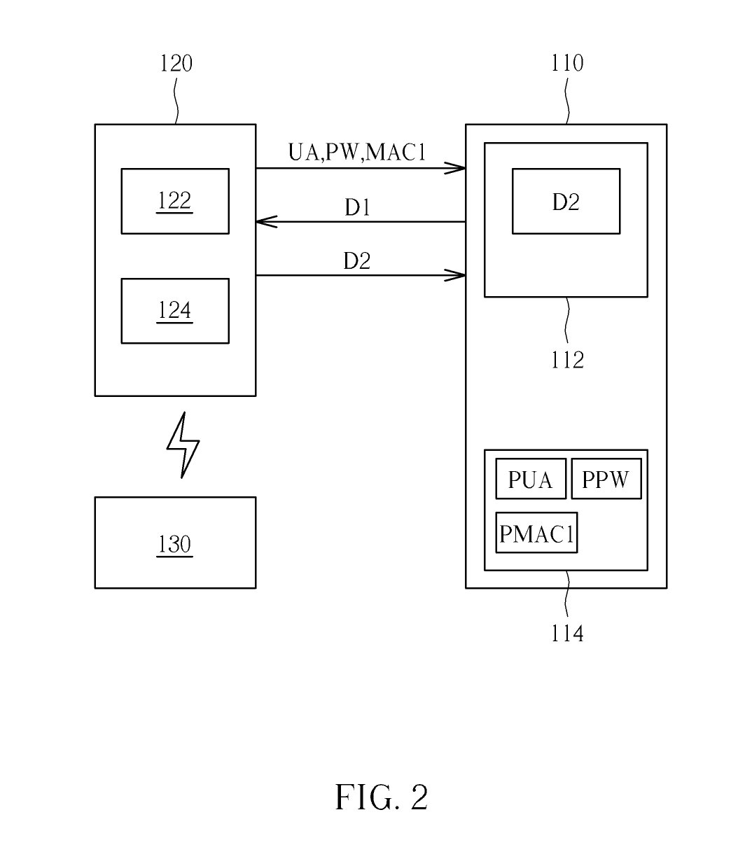

Please refer to FIG. 1 and FIG. 2 together. FIG. 2 is a diagram illustrating a terminal device of the present invention logging in a cloud server. As shown in FIG. 2, the terminal device 120 can login the cloud server 110 via Internet according to a set of user account data. The set of user account data can comprise a user account UA, a password PW and an identification number MAC1 of the terminal device 120. The identification number MAC1 can be utilized for identifying the terminal device 120, for example, the identification number MAC1 can be a media access control address of the terminal device 120, but not limited to it. The set of predetermined account data stored by the verification module 114 can comprise a predetermined user account PUA, a predetermined password PPW and a first predetermined identification number PMAC1. The verification module 114 can determine whether the set of user account data corresponds to the set of predetermined account data when the terminal device 120 logins the cloud server 110. For example, the verification module 114 determines whether the user account UA, the password PW and the identification number MAC1 of the terminal device 120 correspond to the predetermined user account PUA, the predetermined password PPW and the first predetermined identification number PMAC1 respectively. When the verification module 114 determines the set of user account data corresponds to the set of predetermined account data, it means that the terminal device 120 passes verification, and the terminal device 120 then can download peripheral device setting data D1 from the cloud server 110 for setting the terminal device 120 to link to a peripheral device 130. The peripheral device 130 can be a sales data printing device or a barcode scanner, but not limited to it. The terminal device 120 can link to the peripheral device 130 wired or wirelessly. In addition, when the sales module 124 generates a set of sales data D2 according to user input, the terminal device 120 can upload the set of sales data D2 to the sales database 112 immediately when network connection is available, or the terminal device 120 can perform stand-alone operation until network connection is available, and then upload the set of sales data D2 to the sales database 112, in order to precisely perform sales purchasing management.

In an embodiment, the terminal device 120 can also upload a set of member data to the sales database 122 for member management.

According to the above arrangement, when the terminal device 120 logins the cloud server 110 successfully, the terminal device 120 can download the peripheral device setting data D1 for setting the terminal device 120 to link to the peripheral device 130. The terminal device 120 can simply link to the peripheral device 130 without complex setting. Moreover, the verification module 114 can verify the identification number MAC1 of the terminal device 120, such that even the user account UA and the password PW are stolen, other terminal device is still unable to login the cloud server 110.

On the other hand, in other embodiment of the present invention, the point of sale system 100 can comprise a plurality of terminal devices. The verification module 114 can store a plurality of sets of predetermined account data corresponding to the plurality of terminal devices, in order to allow a user to utilize the plurality of terminal devices to login the cloud server, for operating at multiple sites.

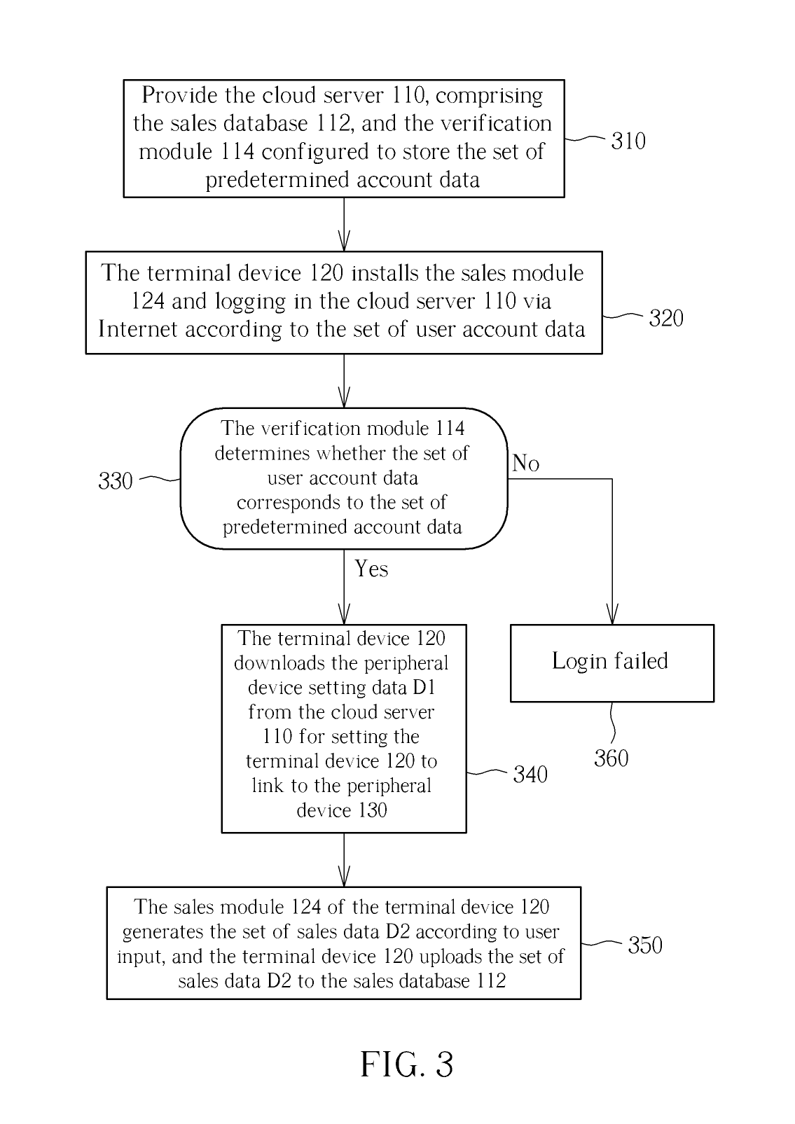

Please refer to FIG. 3. FIG. 3 is a flowchart showing the terminal device of the present invention logging in the cloud server. The flowchart comprises the following steps:

Step 310: Provide the cloud server 110, comprising the sales database 112, and the verification module 114 configured to store the set of predetermined account data;

Step 320: The terminal device 120 installs the sales module 124 and logging in the cloud server 110 via Internet according to the set of user account data;

Step 330: The verification module 114 determines whether the set of user account data corresponds to the set of predetermined account data; if yes, go to step 340; if not, go to step 360;

Step 340: The terminal device 120 downloads the peripheral device setting data D1 from the cloud server 110 for setting the terminal device 120 to link to the peripheral device 130;

Step 350: The sales module 124 of the terminal device 120 generates the set of sales data D2 according to user input, and the terminal device 120 uploads the set of sales data D2 to the sales database 112; and

Step 360: Login failed.

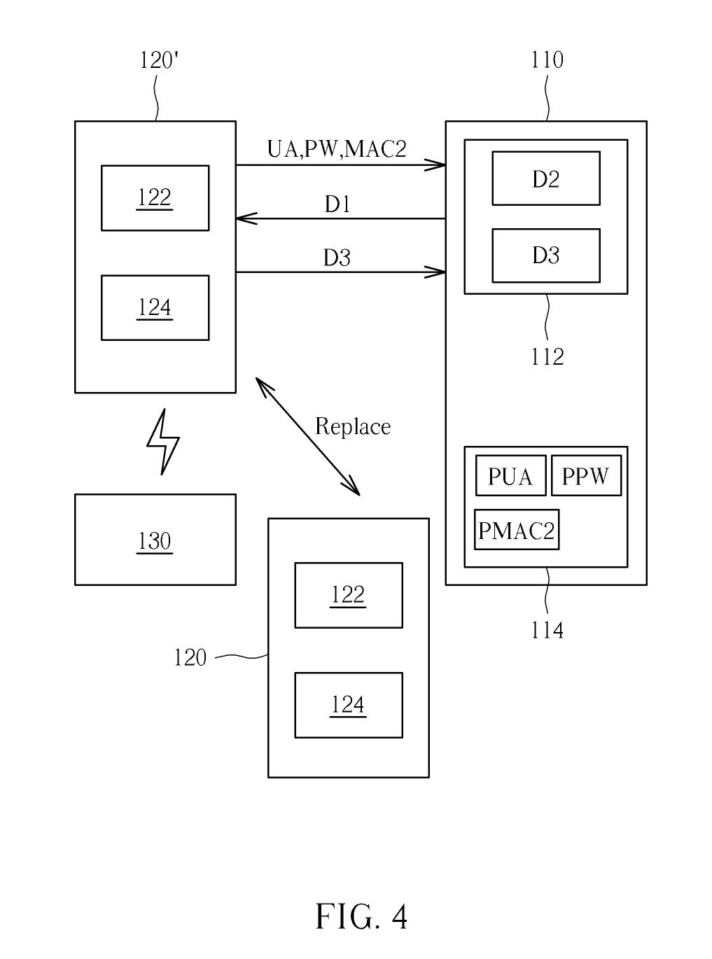

Please refer to FIG. 4, and refer to FIG. 1 as well. FIG. 4 is a diagram illustrating a backup terminal device of the present invention logging in the cloud server for replacing the terminal device. As shown in FIG. 4, when the terminal device 120 is out of order, in order to replace the original terminal device 120 with a backup terminal device 120′, an administrator of the cloud server 110 can login the cloud server 110 by an administrator account, and the administrator of the cloud server 110 can then use the administrator account for changing the first predetermined identification number PMAC1 to a second predetermined identification number PMAC2. Thereafter, the backup terminal device 120′ can login the cloud server 110 via Internet according to the user account UA, the password PW and an identification number MAC2 of the backup terminal device 120′. The verification module 114 then determines whether the user account UA, the password PW and the identification number MAC2 of the backup terminal device 120′ correspond to the predetermined user account PUA, the predetermined password PPW and the second predetermined identification number PMAC2 respectively. When the verification module 114 determines the user account UA, the password PW and the identification number MAC2 of the backup terminal device 120′ corresponding to the predetermined user account PUA, the predetermined password PPW and the second predetermined identification number PMAC2 respectively, it means that the backup terminal device 120′ passes verification. The backup terminal device 120′ then can download the peripheral device setting data D1 from the cloud server 110 for setting the backup terminal device 120′ to link to the peripheral device 130. In addition, when the backup terminal device 120′ generates a set of sales data D3 according to user input, the backup terminal device 120′ can upload the set of sales data D3 to the sales database 112.

According to the above arrangement, when the terminal device 120 is out of order, the user can utilize the backup terminal device 120′ to login the cloud server 110, and download the peripheral device setting data D1 for setting the backup terminal device 120′ to link to the peripheral device 130, such as a sales data printing device or a barcode scanner. Therefore, the backup terminal device 120′ can simply link to the peripheral device 130 without complex setting. Moreover, since the backup terminal device 120′ also installs the sales module 124, which is identical to that of the terminal device 120, the backup terminal device 120′ can provide all functions of the original terminal device 120, in order to completely replace the original terminal device 120.

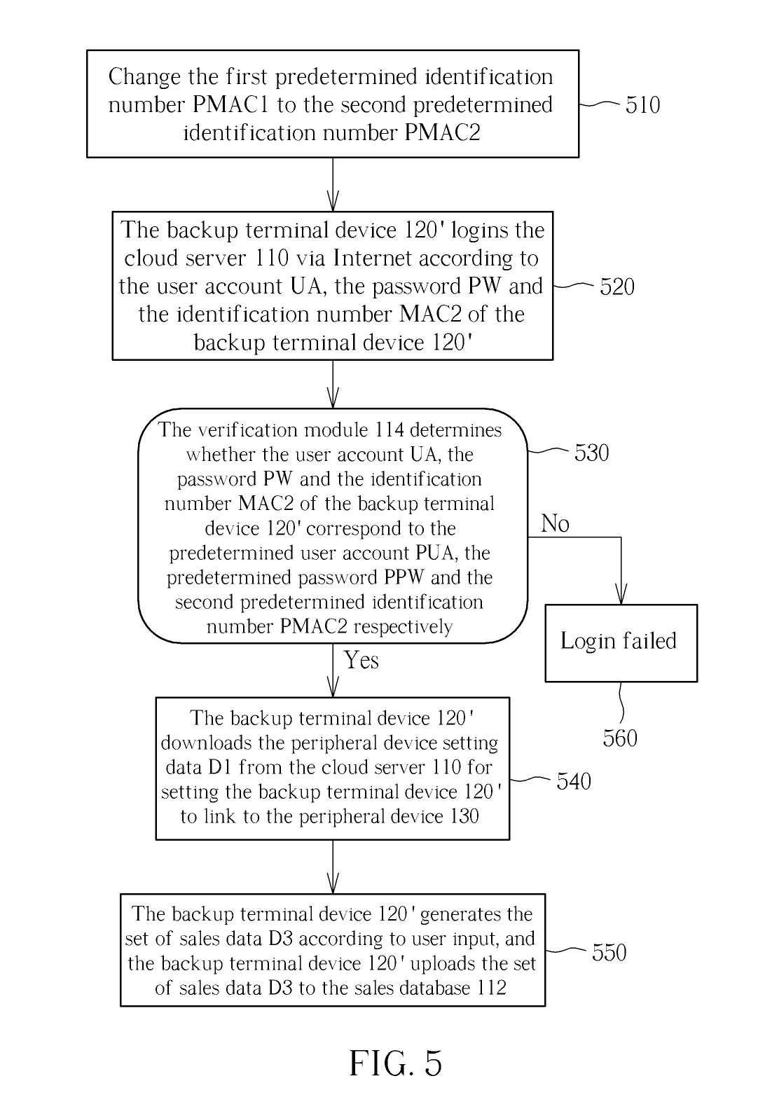

Please refer to FIG. 5. FIG. 5 is a flowchart showing the backup terminal device of the present invention logging in the cloud server for replacing the terminal device. The flowchart comprises the following steps:

Step 510: Change the first predetermined identification number PMAC1 to the second predetermined identification number PMAC2;

Step 520: The backup terminal device 120′ logins the cloud server 110 via Internet according to the user account UA, the password PW and the identification number MAC2 of the backup terminal device 120′;

Step 530: The verification module 114 determines whether the user account UA, the password PW and the identification number MAC2 of the backup terminal device 120′ correspond to the predetermined user account PUA, the predetermined password PPW and the second predetermined identification number PMAC2 respectively; if yes, go to step 540; if not, go to step 560;

Step 540: The backup terminal device 120′ downloads the peripheral device setting data D1 from the cloud server 110 for setting the backup terminal device 120′ to link to the peripheral device 130;

Step 550: The backup terminal device 120′ generates the set of sales data D3 according to user input, and the backup terminal device 120′ uploads the set of sales data D3 to the sales database 112; and

Step 560: Login failed.

In addition, in the present embodiment, the terminal device 120 and the backup terminal device 120′ can be any type of electronic devices, such as personal computers, tablet computers or smartphones, and the terminal device 120 and the backup terminal device 120′ are not necessary to be the same type of electronic devices. The sales module 124 can be application software available from App Store® and/or Google Play® to be installed in corresponding electronic devices. Any type of electronic device can be utilized as a terminal device after installing the sales module 124, such that the point of sale system of the present invention can work in a cross-platform environment.

In contrast to the prior art, when the terminal device is out of order, the point of sale system of the present invention can install corresponding application software in an available electronic device, and use the electronic device as a backup terminal device to login the cloud server, in order to re-download required data to the backup terminal device from the cloud server via Internet, so as to completely replace the original terminal device.

Those skilled in the art will readily observe that numerous modifications and alterations of the device and method may be made while retaining the teachings of the invention. Accordingly, the above disclosure should be construed as limited only by the metes and bounds of the appended claims.

1. A point of sale (POS) system, comprising:
a cloud server, comprising:
a sales database; and
a verification module configured to store a set of predetermined account data; and
a terminal device, comprising:
a network unit configured to link to the cloud server via Internet; and
a sales module configured to generate a set of sales data according to user input;
wherein when the terminal device logins the cloud server via Internet according to a set of user account data, and the verification module determines the set of user account data corresponding to the set of predetermined account data, the terminal device is configured to download peripheral device setting data from the cloud server for setting the terminal device to link to a peripheral device, and the terminal device is further configured to upload the set of sales data to the sales database.

2. The point of sale system of claim 1, wherein the set of predetermined account data comprises a predetermined user account, a predetermined password and a predetermined identification number, and the set of user account data comprises a user account, a password and an identification number of the terminal device.

3. The point of sale system of claim 1, wherein the peripheral device is a sales data printing device or a barcode scanner.

4. The point of sale system of claim 1, wherein the sales module is application software applicable to a smartphone or a tablet computer.

5. An operation method of a point of sale (POS) system, comprising:
providing a cloud server comprising a sales database, and a verification module configured to store a set of predetermined account data;
a terminal device installing a sales module and logging in the cloud server via Internet according to a set of user account data;
the verification module determining whether the set of user account data corresponds to the set of predetermined account data;
the terminal device downloading peripheral device setting data from the cloud server for setting the terminal device to link to a peripheral device when the verification module determines the set of user account data corresponding to the set of predetermined account data; and
the sales module of the terminal device generating a set of sales data according to user input, and the terminal device uploading the set of sales data to the sales database.

6. The operation method of claim 5, wherein the set of predetermined account data comprises a predetermined user account, a predetermined password and a first predetermined identification number, and the set of user account data comprises a user account, a password and an identification number of the terminal device.

7. The operation method of claim 6 further comprising:
changing the first predetermined identification number to a second predetermined identification number;
a backup terminal device logging in the cloud server via Internet according to the user account, the password and an identification number of the backup terminal device;
the verification module determining whether the user account, the password and the identification number of the backup terminal device correspond to the predetermined user account, the predetermined password and the second predetermined identification number respectively;
the backup terminal device downloading the peripheral device setting data from the cloud server for setting the backup terminal device to link to the peripheral device when the verification module determines the user account, the password and the identification number of the backup terminal device corresponding to the predetermined user account, the predetermined password and the second predetermined identification number respectively; and
the backup terminal device generating a set of sales data according to user input, and the backup terminal device uploading the set of sales data to the sales database.

8. The operation method of claim 7, wherein changing the first predetermined identification number to the second predetermined identification number comprises:
an administrator of the cloud server logging in the cloud server by an administrator account; and
the administrator of the cloud server using the administrator account for changing the first predetermined identification number to the second predetermined identification number.

9. The operation method of claim 5, wherein the sales module is application software applicable to a smartphone or a tablet computer.

10. The operation method of claim 5, wherein setting the terminal device to link to the peripheral device comprises:
setting the terminal device to link to a sales data printing device or a barcode scanner.
